(19) United States
(12) Patent Application Publication
(10) Pub. No.: US 2008/0186485 A1
(43) Pub. Date: Aug. 7, 2008

(54) Optical sight with reticle including a quantum-dot light emitter

(76) Inventor: Conrad Stenton, Midland (CA)

Correspondence Address: Benman, Brown & Williams;Ste. 2740, 2049 Century Park East, Los Angeles, CA, 90067, US

(21) Appl. No.: 11/702,760

(22) Filed: Feb. 5, 2007

(51) Int. Cl. G02B 23/10

(52) U.S. Cl. 356/251

(57) ABSTRACT

An optical sight has an optical train defining an optical path and having at least one optical element. The optical train includes as an optical element a reticle having a reticle pattern defined by a quantum-dot light emitter that is excited by light of an excitation wavelength and emits light in a visible wavelength, and a light source producing an output light of the excitation wavelength positioned to direct the output light to be incident upon the quantum-dot light emitter.

This invention relates to an optical sight having a reticle and, more particularly, to such an optical sight wherein the reticle pattern is defined by a quantum-dot light emitter.

### BACKGROUND OF THE INVENTION

Refractive or reflective optical sights are used in a wide variety of applications to obtain increased magnification of a scene. In one common application, an optical sight is affixed to the upper side of the barrel of a rifle-type weapon used by a soldier. The user sights through the optical sight to acquire a target and aim the weapon toward the target to increase the likelihood of hitting the target with a projectile fired from the weapon.

A reticle is typically provided in the optical path of the optical sight. The reticle normally has reference markings or other information that aids the user in aiming the optical sight and thence the weapon toward the intended target. The reference markings usually include a cross hair or similar marking to indicate the bore sight of the weapon. The reference markings may also include elevation, windage, and other reference markings that assist in aiming the weapon.

The reticle may be illuminated by an artificial light source within the optical sight. The reticle illumination ensures that the reticle will be visible in lighting conditions including normal daylight, low-light ambient conditions, and, particularly for infrared and other optical sights to be used at night, in near-darkness conditions. If ambient light is the sole reticle illumination, the illumination may be uneven and undependable.

The illumination of the reticle ideally satisfies a number of requirements. The illumination of the reticle must not interfere with the observation of the scene being viewed, yet the reticle must stand out against the scene. The reticle output desirably is adjustable and has low power consumption. The reticle illumination must be relatively uniform over the entire reticle so that the entire exit pupil is filled. Existing illumination approaches do not fully meet these requirements.

There is a need for an approach to ensure proper illumination of the reticle of an optical sight, so that the reticle always remains visible to the user peering through the optical sight. The present invention fulfills this need, and further provides related advantages.

### SUMMARY OF THE INVENTION

The present approach provides an optical sight having an illuminated reticle. The reticle illumination is fully controllable over a wide range of reticle intensities. The reticle illumination utilizes a highly efficient illumination source whose output wavelength may be selected. The color of the reticle illumination may be selected according to the materials used in the construction of the reticle.

In accordance with the invention, an optical sight comprises an optical train defining an optical path and having at least one optical element. The optical train includes as an optical element a reticle including a reticle pattern defined by a quantum-dot light emitter that is excited by light of an excitation wavelength and emits light in a visible wavelength, and a light source producing an output light of the excitation wavelength positioned to direct the output light to be incident upon the quantum-dot light emitter. The light source is preferably a source of ultraviolet excitation light, and is most preferably an ultraviolet light emitting diode. The optical sight normally includes a housing that encloses the optical train.

The optical train typically has at least one optically powered lens in addition to the reticle. In a typical configuration, there is an objective and eyepiece. There is also optionally but preferably an image erector. The reticle is normally integrated with the image erector or is a freestanding element that lies between the image erector and the eyepiece.

A preferred form of the structure of the reticle includes a reticle substrate that is transparent to light of the excitation wavelength and also is transparent to visible light. A reticle relief pattern is formed into the reticle substrate, typically by etching or engraving. The quantum-dot light emitter material is received into the reticle relief pattern. The light source is desirably positioned at a periphery of the reticle substrate and oriented to direct the output light toward the reticle relief pattern and its quantum-dot light emitter material.

One of the features of the present approach is that there may be a second, independently illuminated reticle pattern. In this case, the reticle pattern overlies a first portion of the reticle. The reticle further includes a second reticle pattern overlying a second portion of the reticle and defined by a second quantum-dot light emitter that is excited by light of a second excitation wavelength and emits light in a second visible wavelength. A second light source produces a second output light of the second excitation wavelength positioned to direct the second output light to be incident upon the second quantum-dot light emitter. The second quantum-dot light emitter may be the same material as the quantum-dot light emitter, or a different material. The second light source may be the same as the light source, or different. The second excitation wavelength may be the same as the excitation wavelength, or different. The second visible wavelength may be the same as the visible wavelength, or different.

In a preferred embodiment, an optical sight comprises an optical train defining an optical path and having at least one optical element. The optical train comprises an optically powered objective, an optically powered eyepiece, and a reticle comprising a reticle pattern defined by a quantum-dot light emitter that is excited by ultraviolet light and emits visible light. The reticle is preferably a freestanding element lying between the objective and the eyepiece. An ultraviolet light source, such as an ultraviolet light emitting diode, is positioned to direct ultraviolet light to be incident upon the quantum-dot light emitter. A housing encloses the optical train. Other compatible features discussed herein may be used with this embodiment.

Most preferably, an optical sight comprises an optical train defining an optical path and having at least one optical element. The optical train comprises an optically powered objective, an image erector, an optically powered eyepiece, and a reticle. The reticle comprises a freestanding reticle substrate that is transparent to ultraviolet light and also is transparent to visible light. The reticle substrate is positioned on the optical path between the objective and the eyepiece. There is a reticle relief pattern formed into the reticle substrate, and a quantum-dot light emitter received into the reticle relief pattern. A cover sheet may be placed over the reticle substrate so as to encapsulate the reticle relief pattern between the reticle substrate and the cover sheet. The quantum-dot light emitter is excited by ultraviolet light and emits visible light. An ultraviolet light source is positioned to direct ultraviolet light to be incident upon the quantum-dot light emitter. A housing encloses the optical train. Other compatible features discussed herein may be used with this embodiment.

The present approach provides a reticle with a controllable light intensity. The use of quantum-dot technology produces a brighter reticle pattern for the power input. The power consumption of the reticle illumination source is small, an important consideration because the power source is preferably a battery. The lower the power consumption, the smaller the battery or the longer the battery life. Additionally, the color of the reticle pattern may be selected according to the composition and size of the nanodots that form the quantum-dot light-emitter material.

Other features and advantages of the present invention will be apparent from the following more detailed description of the preferred embodiment, taken in conjunction with the accompanying drawings, which illustrate, by way of example, the principles of the invention. The scope of the invention is not, however, limited to this preferred embodiment.

### BRIEF DESCRIPTION OF THE DRAWINGS

FIG. 1 is a block diagram of an optical sight;

FIG. 2 is a lengthwise sectional view of one physical embodiment of the optical sight of FIG. 1;

FIG. 3 is a front elevational view of a reticle;

FIG. 4 is a schematic sectional detail view of the reticle of FIG. 2; and

FIG. 5 is a front elevational view of a reticle.

### DETAILED DESCRIPTION OF THE INVENTION

FIG. 1 depicts in general form an optical sight 20 according to the present approach. The optical sight 20 comprises optical elements including an objective 22, a reticle 24, and an eyepiece 26. Each of the objective 22 and the eyepiece 26 preferably includes one or more optically powered lenses. The objective 22, the reticle 24, and the eyepiece 26 together constitute an optical train 28 with an optical path 30 (of vector form) therethrough. Light travels along the optical path 30 from a scene to the objective 22, from the objective 22 to the eyepiece 26, and from the eyepiece 26 to an eye 32 of the user of the optical sight. The reticle 24 is superimposed upon and coincident with the optical path 30 at some point before the optical path 30 enters the eye 32 of the user, but typically after the objective 22, so that the optical path 30 passes through, or is reflected from, the reticle 24 as well. Thus, for example, the reticle 24 could be a part of the eyepiece, although it is shown as a separate element in FIG. 1. The reticle 24 is illuminated by a reticle illumination source 34.

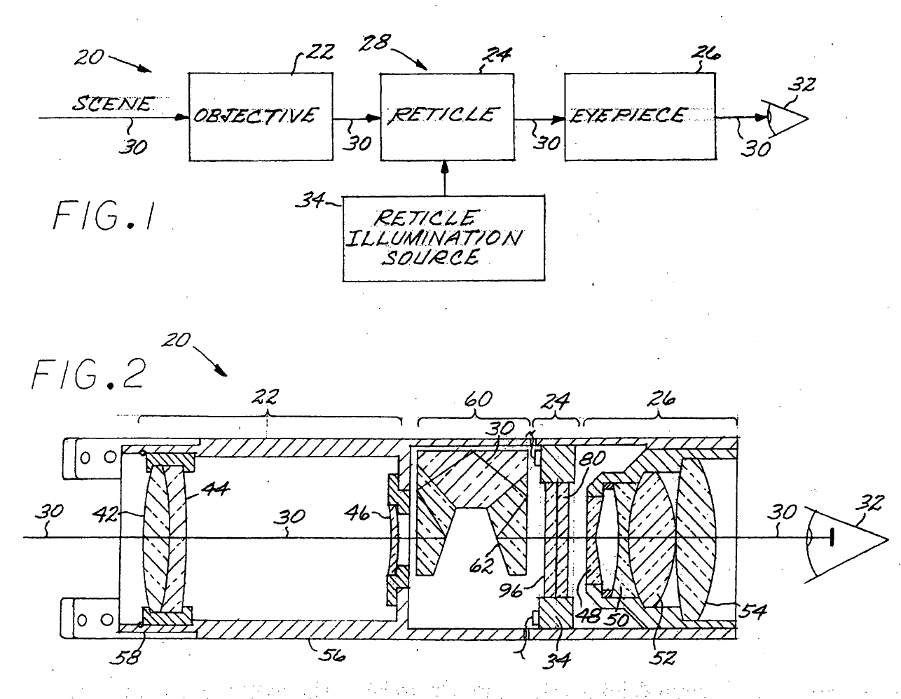

FIG. 2 depicts a preferred embodiment of the optical sight 20 shown generally in FIG. 1. Previously described elements are indicated, and the prior description is incorporated. The objective 22 includes three objective lenses 42, 44, and 46, with lenses 42 and 44 a cemented doublet. The eyepiece 26 includes four eyepiece lenses 48, 50, 52, and 54. This arrangement of the lenses for the objective 22 and the eyepiece 26 is illustrative. Other types of objectives 22 and eyepieces 26 may be used, including those in which some or all of the elements are reflective elements rather than refractive elements. All of the elements are enclosed in a housing 56, which has an attachment 58 for attaching the housing 56 to a rifle or other structure (not shown) that is to be aimed with the assistance of the optical sight 20.

The objective 22 inverts the image from the scene as it travels along the optical path 30. To re-invert the image so that it may be comfortably viewed by the user without changing the magnification of the image, an optional optically unpowered image erector (also called an image inverter), illustrated as an erector prism 60, is positioned on the optical path 30 as an additional optical component between the objective 22 and the eyepiece 26. The erector prism 60 includes mirror surfaces provided as three prism elements, and the optical path 30 is reflected from reflecting surfaces of the erector prism 60 as it passes through the erector prism 60 as illustrated in FIG. 2. The optical path 30 leaves the erector prism 60 on its way to the eyepiece 26 after reflecting from a final reflecting surface 62.

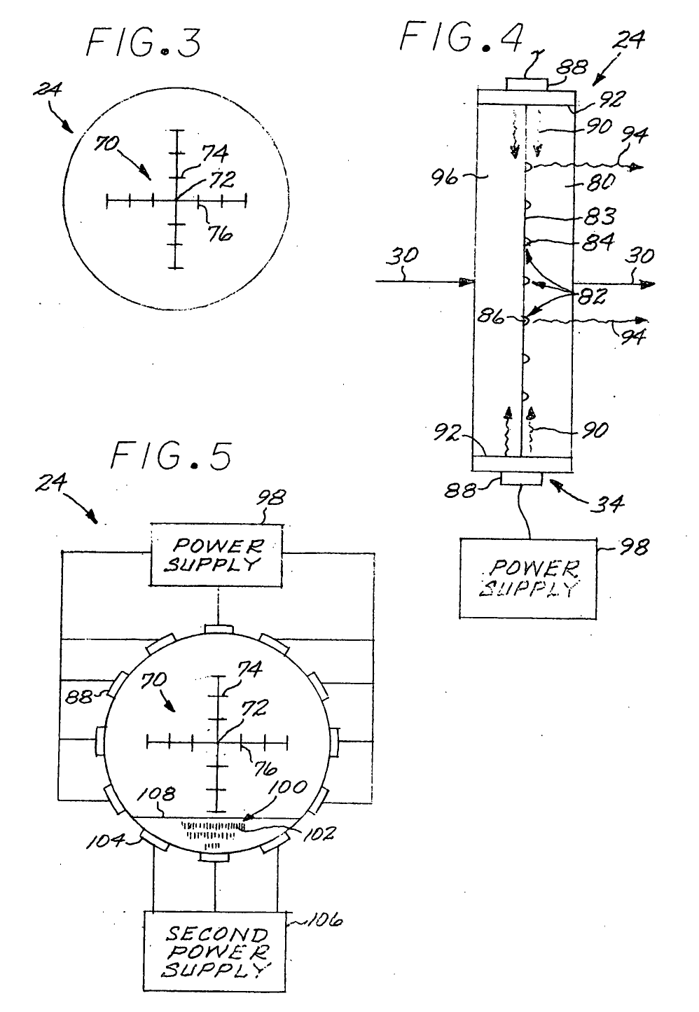

The reticle 24 includes a reticle pattern 70 of markings that provide a spatial reference for the user looking through the optical sight 20. FIG. 3 illustrates a typical reticle pattern 70. There is typically a boresight marking 72, such as a cross hair, and there may be other markings such as elevation markings 74 and/or windage markings 76. The reticle 24 may be a preferred freestanding element, or it may be defined on a surface through which the optical path 30 passes or from which the optical path 30 is reflected. The preferred freestanding reticle 24 will be described in more detail herein, but the principles are applicable to a reticle integral with the image erector or other optical component. The freestanding reticle 24 may be positioned between the objective 22 and the eyepiece 26 as illustrated, or may be positioned between or upon some of the individual elements of the eyepiece 26.

FIG. 4 depicts the reticle 24 in greater detail. The reticle 24 includes a reticle substrate 80 and a reticle relief pattern 82 formed into a surface 83 of the reticle substrate 80. The individual recesses 84 of the reticle relief pattern 82 correspond to and define the desired reticle pattern 70. The individual recesses 84 of the reticle relief pattern 82 are formed into the substrate 80 by any operable approach, with etching or engraving being preferred. The width and depth of the individual recesses 84 are not critical, but the width of the recess 84 is typically about 8 micrometers and the depth is typically about 3 micrometers.

A quantum-dot light emitter 86 is received into the reticle relief pattern 82, and specifically into the individual recesses 84. The quantum-dot (also sometimes termed “nano-dot”) light emitter is a nanophosphor material formed. of a mass of particles of phosphorescent material having particle sizes much smaller than the wavelength of visible light. These quantum-dot light emitters are excited by light of an excitation wavelength and emit light of an output wavelength. For the present application, the output wavelength is in the visible wavelength range, so that the light output is visible to the unaided human eye 32 peering through the optical sight 20. The excitation wavelength is preferably a non-visible wavelength so that the excitation light is not visible to the unaided human eye. Most preferably, the excitation wavelength is in the ultraviolet wavelength range, typically less than about 450 nanometers wavelength, and most preferably about 395-400 nanometers wavelength.

Operable quantum-dot light emitters 86 include materials such as cadmium sulfide, cadmium telluride, silicon, and germanium, processed with a surfactant to a very small nano-dot size much smaller than the wavelength of visible light, and encapsulated. Quantum-dot light emitters are described, for example, in U.S. Pat. Nos. 7,078,276; 6,918,946; and 6,251,303, whose disclosures are incorporated by reference. Quantum-dot light emitters are available commercially from companies such as American Dye Source, Inc., Baie d'Urfe, Quebec Canada.

The selection of quantum-dot light emitters has several important advantages for forming a reticle pattern 70. Because the nano-dots (i.e., quantum-dots) are small, a large fraction of the atoms in each nano-dot are near the surface of the nano-dot, and accordingly can participate in the light-emission process. The energy-conversion efficiency of the quantum-dot light emitter 86 is therefore very high, reducing the power required to form the illuminated reticle pattern 70. The emitted light wavelength is determined by both the chemical composition of the nano-dots and also their size. Accordingly, the apparent color of the reticle pattern 70 in the visible wavelength range may be controlled according to the selected chemical composition and size of the nano-dots.

The reticle 24 further includes a light source 88 producing an output light 90 of the excitation wavelength, an ultraviolet wavelength in the preferred application. The light source 88 is positioned to direct the output light 90 to be incident upon the quantum-dot light emitter 86 as its excitation light. The light source 88 is preferably an ultraviolet-wavelength (UV) light-emitting diode (LED). Such UV LEDs are available commercially from companies such as Kingbright Corporation, City of Industry, Calif. In the embodiment illustrated in FIG. 4, the light source 88 includes a number of UV LEDs positioned around a periphery 92 of the reticle substrate 80. The UV LEDs are oriented to direct their output light 90 toward the quantum-dot light emitters 86 within the reticle relief pattern 82. When the output light 90 is incident upon the quantum-dot light emitter 86 as its excitation-wavelength light, the quantum-dot light emitter 86 emits visible-wavelength light 94 to the eye 32 of the user who is peering through the optical sight 20.

The reticle substrate 80 is preferably covered with a cover sheet 96 to protect the quantum-dot light emitter 86 within the individual recesses 84 of the reticle-relief pattern 82. The reticle substrate 80 and the cover sheet 96 are made of a material, such as a glass, that is transparent to the output light 90 of the excitation wavelength and transparent to the visible-wavelength light 94.

As shown in FIG. 4, the light sources 88 are powered by a power supply 98. The power supply 98 preferably includes a battery and is preferably of a controllable output power, so that the intensity of the excitation-wavelength light of the output light 90 produced by the light sources 88 may be adjusted by the user.

In another reticle illustrated in FIG. 5, two independently illuminated reticle patterns may be present in the same reticle 24. The reticle pattern 70 overlies a first portion of the area of the reticle 24. A second reticle pattern 100 overlies a second portion of the area of the reticle 24. The second reticle pattern 100 may be information that is to be presented to the user of the optical sight 20 separately and independently of the reticle pattern. The second reticle pattern 100 is defined by a second quantum-dot light emitter 102 that is excited by light of a second excitation wavelength, and emits light in a second visible wavelength. The second reticle pattern 100 is formed in the reticle substrate 80 in a manner like that discussed above for the reticle pattern 70.

The second excitation wavelength associated with the second reticle pattern 100 may be the same as the excitation wavelength associated with the reticle pattern 70, or it may be different. The second visible wavelength associated with the second reticle pattern 100 may be the same as the visible wavelength associated with the reticle pattern 70, or it may be different. A second light source 104 produces a second output light of the second excitation wavelength positioned to direct the second output light to be incident upon the second quantum-dot light emitter 102. The second light source 104 may be of the same type as the light source 88, or it may be different. However, preferably the second light source 104 is different from the light source 88, so that the two reticle patterns 70 and 100 may be independently illuminated. For this latter and most general case, a second power supply 106 is provided. Where the reticle pattern 70 and the second reticle pattern 100 are independently illuminated, for example at different excitation wavelengths, it is preferred that a light barrier 108, such as an opaque layer, be placed in the reticle substrate 80 between the reticle pattern 70 and the second reticle pattern 100. The second reticle pattern 100 otherwise functions in the same manner as the previously described reticle pattern 70, and the prior description is incorporated.

In yet another form, the reticle may be in an existing optical surface of the optical sight 20 lying in the optical path 30. For example, the reticle relief pattern 82 may be formed into the final reflecting surface 62, or the reticle substrate 80, having the reticle relief pattern 82 herein, may be placed into facing contact with the final reflecting surface 62. These forms of the reticle 24 are otherwise constructed and operated as described above, which description is incorporated here. There is then no need for the freestanding reticle 24 such as illustrated in FIG. 2.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An optical sight, comprising:
an optical train defining an optical path and having at least one optical element, wherein the optical train includes as an optical element a reticle, and wherein the reticle comprises
a reticle pattern defined by a quantum-dot light emitter that is excited by light of an excitation wavelength and emits light in a visible wavelength, and
a light source producing an output light of the excitation wavelength positioned to direct the output light to be incident upon the quantum-dot light emitter.

2. The optical sight of claim 1, wherein the optical train includes at least one optically powered lens in addition to the reticle.

3. The optical sight of claim 1, wherein the optical train includes
an objective,
an image erector, and
an eyepiece.

4. The optical sight of claim 1, wherein the optical train includes
an objective,
an image erector, and
an eyepiece,
and wherein the reticle is integrated with the image erector or lies between the image erector and the eyepiece.

5. The optical sight of claim 1, wherein the light source is a source of ultraviolet excitation light.

6. The optical sight of claim 1, wherein the light source is an ultraviolet light emitting diode.

7. The optical sight of claim 1, further including a housing that encloses the optical train.

8. The optical sight of claim 1, wherein the reticle comprises
a reticle substrate that is transparent to light of the excitation wavelength and also is transparent to visible light,
a reticle relief pattern formed into the reticle substrate, and
the quantum-dot light emitter received into the reticle relief pattern.

9. The optical sight of claim 1, wherein the reticle comprises
a reticle substrate that is transparent to light of the excitation wavelength and also is transparent to visible light,
a reticle relief pattern formed into the reticle substrate,
the quantum-dot light emitter received into the reticle relief pattern, and wherein the light source is positioned at a periphery of the reticle substrate and oriented to direct the output light toward the reticle relief pattern.

10. The optical sight of claim 1, wherein the reticle pattern overlies a first portion of the reticle, and further including
a second reticle pattern overlying a second portion of the reticle and defined by a second quantum-dot light emitter that is excited by light of a second excitation wavelength and emits light in a second visible wavelength, and
a second light source producing a second output light of the second excitation wavelength positioned to direct the second output light to be incident upon the second quantum-dot light emitter.

11. An optical sight, comprising:
an optical train defining an optical path and having at least one optical element, wherein the optical train comprises
an optically powered objective,
an optically powered eyepiece, and
a reticle comprising
a reticle pattern defined by a quantum-dot light emitter that is excited by ultraviolet light and emits visible light, and
an ultraviolet light source positioned to direct ultraviolet light to be incident upon the quantum-dot light emitter; and
a housing that encloses the optical train.

12. The optical sight of claim 11, wherein the reticle is a freestanding element lying between the objective and the eyepiece.

13. The optical sight of claim 11, wherein the light source is an ultraviolet light emitting diode.

14. The optical sight of claim 11, wherein the reticle comprises
a reticle substrate that is transparent to ultraviolet light and also is transparent to visible light,
a reticle relief pattern formed into the reticle substrate, and
the quantum-dot light emitter received into the reticle relief pattern.

15. The optical sight of claim 11, wherein the reticle comprises
a reticle substrate that is transparent to ultraviolet light and also is transparent to visible light,
a reticle relief pattern formed into the reticle substrate, and
the quantum-dot light emitter received into the reticle relief pattern. and wherein the light source is positioned at a periphery of the reticle substrate and oriented to direct ultraviolet light toward the reticle relief pattern.

16. An optical sight, comprising:
an optical train defining an optical path and having at least one optical element, wherein the optical train comprises
an optically powered objective,
an image erector,
an optically powered eyepiece, and
a reticle comprising
a freestanding reticle substrate that is transparent to ultraviolet light and also is transparent to visible light, wherein the reticle substrate is positioned on the optical path between the objective and the eyepiece,
a reticle relief pattern formed into the reticle substrate,
a quantum-dot light emitter received into the reticle relief pattern, wherein the quantum-dot light emitter is excited by ultraviolet light and emits visible light, and
an ultraviolet light source positioned to direct ultraviolet light to be incident upon the quantum-dot light emitter; and
a housing that encloses the optical train.

17. The optical sight of claim 16, wherein the light source is an ultraviolet light emitting diode.

18. The optical sight of claim 16, wherein the light source is positioned at a periphery of the reticle substrate and oriented to direct ultraviolet light toward the reticle relief pattern.
